(19) United States
(12) Patent Application Publication
(10) Pub. No.: US 2011/0109668 A1
(43) Pub. Date: May 12, 2011

(54) DISPLAY DRIVING CIRCUIT AND DISPLAY DRIVING SYSTEM

(75) Inventors: Takuya TAKEUCHI, Osaka (JP); Takaaki ISHII, Osaka (JP); Masanori MIYAO, Osaka (JP)

(73) Assignees: SANYO ELECTRIC CO., LTD., Osaka (JP); SANYO SEMICONDUCTOR CO., LTD., Gunma (JP); SHARP KABUSHIKI KAISHA, Osaka (JP)

(21) Appl. No.: 12/941,187

(22) Filed: Nov. 8, 2010

(30) Foreign Application Priority Data
Nov. 9, 2009 (JP) 2009-256276

(51) Int. Cl. G09G 5/10

(52) U.S. Cl. 345/691

(57) ABSTRACT

A display driving device (50) which drives a display device of a display channel unit (20) according to a time-sequential color representation instruction from a control device (30) comprises a table generating unit (64) which generates a table necessary for driving according to the color representation instruction based on pallet data which is a driving condition of a display device corresponding to a color representation and according to the time-sequential color representation instruction which is instructed in advance, a table storage unit (62) which stores these tables, and a pallet data setting unit (76) which refers to these tables, obtains pallet data corresponding to each lighting cycle, assigns the obtained pallet data while sequentially switching the pallet data according to switching of the lighting cycle, and sets the driving condition of each display device of the display channel unit.

### CROSS-REFERENCE TO RELATED APPLICATIONS

The entire disclosure of Japanese Patent Application No. 2009-256276 filed on Nov. 9, 2009, including specification, claims, drawings, and abstract, is incorporated herein by reference in its entirety.

### BACKGROUND

1. Technical Field

The present invention relates to a display driving circuit and a display driving system including a plurality of display devices which can display in different colors from each other.

2. Background Art

Display devices are developed which achieve a variety of color representation using a plurality of display devices which can display in different colors from each other. For example, Patent Literature 1 (JP 2003-273969 A) discloses a method of controlling a display in a portable terminal in which a music code of a music piece for notifying of incoming call is searched, lighting color change pattern data for changing the lighting color according to the pitch of the sound corresponding to the music code is read from a storage region, an LED (Light Emission Device) driving unit is controlled, and a red LED, a green LED, and a blue LED of an incoming call notifying lamp are driven and lighted with a set lighting color change pattern.

In this technique, a lighting color corresponding to the pitch of the sound of the music code is set, and a lighting color change pattern is generated in advance and stored in a storage region. For example, when the red color is set for the sound of do, the green color is set for the sound of re, the yellow color is set for the sound of mi, and the purple color is set for the sound of sol corresponding to the pitch of the sound in do, re, mi, fa, and sol, for a music code of do-re-mi-sol-do, a lighting color changing pattern of red-green-yellow-purple-red is generated and stored in the storage region.

According to the technique of Patent Literature 1 (JP 2003-273969 A), by using LEDs of three colors and storing the lighting color change pattern in the storage region in advance, it is possible to achieve lighting of a variety of lighting colors corresponding to the pitch of the sound. In this technique, a relationship between the pitch of the sound and the lighting color is set in advance, and a lighting color change pattern corresponding to the music code is generated and stored. Because of this, changing or the like of the lighting color at a later time requires some labor. For example, when the relationship between the pitch of the sound and the lighting color is to be changed, for example, when the color corresponding to the sound of re is to be changed to yellow and the color corresponding to the sound of mi is to be changed to green in the above-described example configuration, the entire lighting color change pattern must be generated again.

In this manner, in the related art, although a variety of color representations can be achieved using a plurality of display devices which can display in different colors from each other, once the lighting color change pattern is set, the changing of the content of the pattern cannot be easily achieved.

### SUMMARY

According to one aspect of the present invention, there is provided a display driving circuit connected to a display channel unit which comprises a plurality of display devices which can display in different colors from each other and which enables a plurality of types of color representations by time-sequentially changing each of drive conditions of the display devices, the display driving circuit comprising a channel driving unit which can drive the plurality of the display devices of the display channel unit independently from each other, and a pallet data setting unit which uses a plurality of types of pallet data correlating a channel driving condition which is a driving condition of each display device of the display channel unit and each type of color representation, manages a time-sequential color representation instruction which is instructed in advance in a separated manner into the pallet data correlated to the color representation and information representing a movement of the color representation on a time axis, assigns the pallet data corresponding to each color representation along a time sequence according to the time-sequential color representation instruction which is instructed in advance, and sets the driving conditions of the plurality of the display devices of the display channel unit.

According to another aspect of the present invention, there is provided a display driving circuit connected to a display channel unit which comprises a plurality of display devices which can display in different colors from each other and which enables a plurality of types of color representations by time-sequentially changing each of driving conditions of the display devices, the display driving circuit comprising a channel driving unit which can drive the plurality of the display devices of the display channel unit independently from each other, a cycle switching unit which switches, for a plurality of lighting cycles, the lighting cycle sequentially to a next lighting cycle every time a lighting period of the lighting cycle elapses, a table storage unit which stores a table generated based on a plurality of types of pallet data correlating a channel driving condition which is a driving condition of each display device of the display channel unit and each type of color representation and according to a time-sequential color representation instruction which is instructed in advance, the table storage unit storing a pallet data table associating the pallet data correlated to the color representation and a pallet number and a time-sequential pallet number table associating an order of the lighting cycle and the pallet number, and a pallet data setting unit which refers to the stored pallet data table and the stored time-sequential pallet number table, obtains pallet data corresponding to each lighting cycle, assigns the obtained pallet data while sequentially switching the pallet data according to switching of the lighting cycle, and sets the driving condition of each display device of the display channel unit.

According to another aspect of the present invention, there is provided a display driving circuit connected to a plurality of groups of display channel units in which a plurality of display devices which can display in different colors from each other are combined into a group and which enables a plurality of types of color representations by time-sequentially changing each of driving conditions of the display devices for each group distinguished by a channel unit number, the display driving circuit comprising a plurality of groups of channel driving units each of which is provided for each display channel unit and each of which can drive the plurality of the display devices of the display channel unit independently from each other, a cycle switching unit which switches, for a plurality of lighting cycles, the lighting cycle sequentially to a next lighting cycle every time a lighting period of the lighting cycle elapses, and a pallet data setting unit which uses a plurality of types of pallet data correlating a channel driving condition which is a driving condition of each display device of the display channel unit and each type of color representation, manages a time-sequential color representation instruction which is instructed in advance in a separated manner to the pallet data correlated to the color representation and information representing a movement of the color representation on a time axis, obtains pallet data corresponding to each display channel unit for each lighting cycle according to the time-sequential color representation instruction which is instructed in advance, assigns the obtained pallet data while sequentially switching the pallet data according to switching of the lighting cycle, and sets the driving condition of each display device of the display channel unit.

According to another aspect of the present invention, there is provided a display driving circuit connected to a plurality of groups of display channel units in which a plurality of display devices which can display in different colors from each other are combined into a group and which enables a plurality of types of color representations by time-sequentially changing each of driving conditions of the display devices for each group distinguished by a channel unit number, the display driving circuit comprising a plurality of groups of channel driving units each of which is provided for each display channel unit and each of which can drive the plurality of the display devices of the display channel unit independently from each other, a cycle switching unit which switches, for a plurality of lighting cycles, the lighting cycle sequentially to a next lighting cycle every time a lighting period of the lighting cycle elapses, a table storage unit which stores a table generated based on a plurality of types of pallet data correlating a channel driving condition which is a driving condition of each display device of the display channel unit and each type of color representation and according to a time-sequential color representation instruction which is instructed in advance, the table storage unit storing a pallet data table associating the pallet data correlated to the color representation and a pallet number, and a time-sequential pallet number table associating a channel unit number for each order of lighting cycle and the pallet number, and a pallet data setting unit which refers to the stored pallet data table and the stored time-sequential pallet number table, obtains pallet data corresponding to each channel unit number for each lighting cycle, assigns the obtained pallet data while sequentially switching the pallet data according to switching of the lighting cycle, and sets the driving condition of each display device of the display channel unit.

According to another aspect of the present invention, it is preferable that, in the display driving circuit, the table storage unit stores, as the pallet data table, a pallet data table generated in synchronization with switching timing of the lighting cycle.

According to another aspect of the present invention, it is preferable that, in the display driving circuit, in the pallet data table, association of a plurality of pallet numbers which differ from each other with pallet data representing the same color representation is permitted.

According to another aspect of the present invention, it is preferable that, in the display driving circuit, in the time-sequential pallet number table, a common pallet number is assigned to pallet numbers of lighting cycles in which the same color representation is realized.

According to another aspect of the present invention, it is preferable that, in the display driving circuit, the table storage unit includes, as the pallet data, ON-OFF data and display grayscale data for each display device.

According to another aspect of the present invention, it is preferable that, in the display driving circuit, the channel driving unit drives an LED as the display device.

According to another aspect of the present invention, there is provided a display driving system comprising a control device which provides a time-sequential color representation instruction and a display driving circuit which obtains the time-sequential color representation instruction and drives a plurality of display devices, wherein the display driving circuit is connected to a plurality of groups of display channel units in which a plurality of display devices which can display in different colors from each other are combined into a group and which enables a plurality of types of color representations by time-sequentially changing each of driving conditions of the display devices for each group distinguished by a channel unit number, and the display driving circuit comprises a plurality of groups of channel driving units each of which is provided for each display channel unit and each of which can drive the plurality of the display devices of the display channel unit independently from each other, a cycle switching unit which switches, for a plurality of lighting cycles, the lighting cycle sequentially to a next lighting cycle every time a lighting period of the lighting cycle elapses, and a pallet data setting unit which uses a plurality of types of pallet data correlating a channel driving condition which is a driving condition of each display device of the display channel unit and each type of color representation, manages a time-sequential color representation instruction which is instructed in advance in a separated manner to the pallet data correlated to the color representation and information representing a movement of the color representation on a time axis, obtains pallet data corresponding to each display channel unit for each lighting cycle according to the time-sequential color representation instruction which is instructed in advance, assigns the obtained pallet data while sequentially switching the pallet data according to switching of the lighting cycle, and sets the driving condition of each display device of the display channel unit.

According to another aspect of the present invention, there is provided a display driving system comprising a control device which provides a time-sequential color representation instruction and a display driving circuit which obtains the time-sequential color representation instruction and drives a plurality of display devices, wherein the display driving circuit is connected to a plurality of groups of display channel units in which a plurality of display devices which can display in different colors from each other are combined into a group and which enables a plurality of types of color representations by time-sequentially changing each of driving conditions of the display devices for each group distinguished by a channel unit number, and the display driving circuit comprises a plurality of groups of channel driving units each of which is provided for each display channel unit and each of which can drive the plurality of the display devices of the display channel unit independently from each other, a cycle switching unit which switches, for a plurality of lighting cycles, the lighting cycle sequentially to a next lighting cycle every time a lighting period of the lighting cycle elapses, an obtaining unit which obtains the time-sequential color representation instruction, a table generating unit which generates a table necessary for channel driving based on a plurality of types of pallet data correlating a channel driving condition which is a driving condition of each display device of the display channel unit and each type of color representation and according to the obtained time-sequential color representation instruction, the table generating unit generating a pallet data table associating the pallet data correlated with the color representation and a pallet number, and a time-sequential pallet number table associating a channel unit number for each order of the lighting cycle and the pallet number, a table storage unit which stores the generated table, and a pallet data setting unit which refers to the stored pallet data table and the stored time-sequential pallet number table, obtains pallet data corresponding to each channel unit number for each lighting cycle, assigns the obtained pallet data while sequentially switching the pallet data according to switching of the lighting cycle, and sets the driving condition of each display device of the display channel unit.

According to another aspect of the present invention, it is preferable that, in the display driving system, the table storage unit of the display driving circuit stores, as the pallet data table, a pallet data table generated in synchronization with switching timing of the lighting cycle.

According to another aspect of the present invention, it is preferable that, in the display driving circuit of the display driving system, in the pallet data table, association of a plurality of pallet numbers which differ from each other with pallet data representing the same color representation is permitted.

According to another aspect of the present invention, it is preferable that, in the display driving circuit of the display driving system, in the time-sequential pallet number table, a common pallet number is assigned to pallet numbers of lighting cycles in which the same color representation is realized.

According to another aspect of the present invention, it is preferable that, in the display driving system, the table storage unit of the display driving circuit includes, as the pallet data, ON-OFF data and display grayscale data for each display device.

According to another aspect of the present invention, it is preferable that, in the display driving system, the channel driving unit of the display driving circuit drives an LED as the display device.

### BRIEF DESCRIPTION OF THE DRAWINGS

Preferred embodiments of the present invention will be described in detail based on the following drawings, wherein:

FIG. 1 is a diagram for explaining a structure of a display driving system having one display channel unit in a preferred embodiment of the present invention;

FIG. 2 is a detailed structural diagram of FIG. 1;

FIG. 3 is a diagram explaining an operation in the structure of FIGS. 1 and 2;

FIG. 4 is a diagram for explaining a lighting sequence in a display driving method of related art;

FIG. 5 is a diagram for explaining a structure of a display driving system having 12 display channel units in a preferred embodiment of the present invention;

FIG. 6 is a detailed structural diagram of FIG. 5;

FIG. 7 is a diagram for explaining another example configuration of table generation according to a color representation instruction in a preferred embodiment of the present invention;

FIG. 8 is a diagram for explaining yet another example configuration of table generation according to a color representation instruction in a preferred embodiment of the present invention; and

FIG. 9 is a diagram for explaining another example configuration of table generation according to a color representation instruction in a preferred embodiment of the present invention.

### DESCRIPTION OF EMBODIMENTS

Preferred embodiments of the present invention will now be described in detail with reference to the attached drawings. In the following description, as display devices which are a part of a display channel unit, a red LED (R-LED), a green LED (G-LED), and a blue LED (B-LED) will be exemplified, but the present invention is not limited to such a configuration, and LEDs of other colors may be used. Alternatively, the display device may be a display device other than LED so long as the display device is driven by an electric signal. For example, the display device may be a self-emitting element other than an LED or a passive display element. Alternatively, a color pixel forming a part of a liquid crystal display may be used as the display device.

In addition, in the following description, the number of LEDs of the display channel unit will be described as one per color, but, in consideration of the fact that, for example, the human vision has a lower sensitivity to the brightness of green LED (G-LED), more than one LED of the same color may be used. For example, the number of green LEDs may be 2 while the numbers of LEDs of other colors are 1.Alternatively, the number of LEDs of colors other than the green LED may be increased, and the increase number may be arbitrarily set. In this manner, the LEDs of the display channel unit may include LEDs of the same color, or a plurality of LEDs may be connected in parallel for one control.

Moreover, in the following description, the number of display devices of the display channel unit will be explained as 3 and cases will be described with a number of display channel units of 1 and 12. However, these configurations are merely exemplary, and a different number of display devices and a different number of display channel units may be employed.

Furthermore, the time-sequential color representation described below is also merely exemplary, and a variety of color representations other than the exemplified configuration may be used so long as the color representation is within a range of a number of types of combinations of the pallet data.

In the following, a display driving circuit is described as an IC (Integrated Circuit). In addition, a display device is connected to the display driving circuit and the display driving circuit is connected to an external control circuit, and generation of a table related to pallet data according to a time-sequential color representation instruction from the external control circuit is described as a function of the display driving circuit. However, the functions of the IC in which the display driving circuit is integrated may be suitably distributed between the IC and the external control circuit. The display driving circuit only needs to have the function to drive a plurality of display devices and a function to set pallet data to time-sequentially as sign the pallet data to a driving unit for the display device, and the other functions may be set as functions of the external control circuit. For example, the function to generate the table may be set as a function of the control circuit, and the display driving circuit may assign the pallet data shown in the table according to the actual timing of lighting switch.

In the following, similar elements in all drawings are assigned the same reference numeral, and will not be repeatedly described. In the description, reference numerals that are already mentioned will be referred to as necessary.

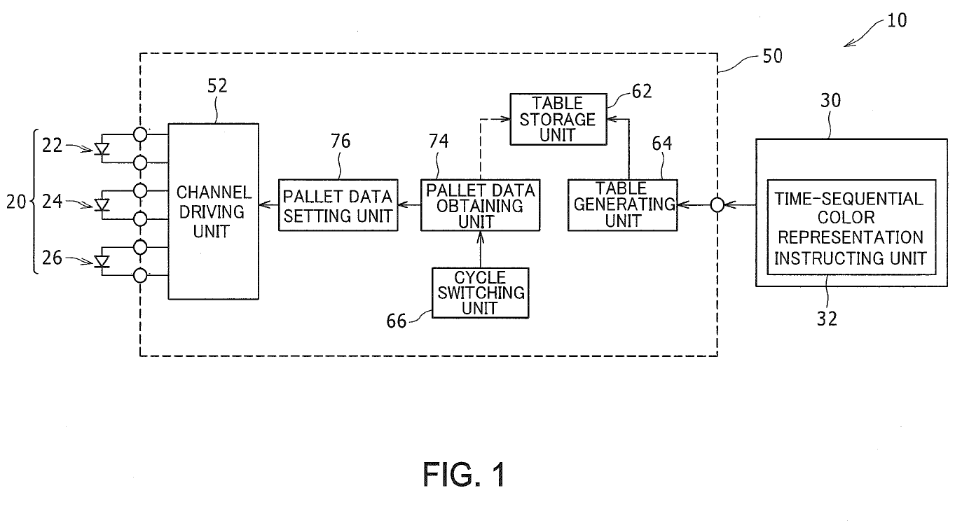

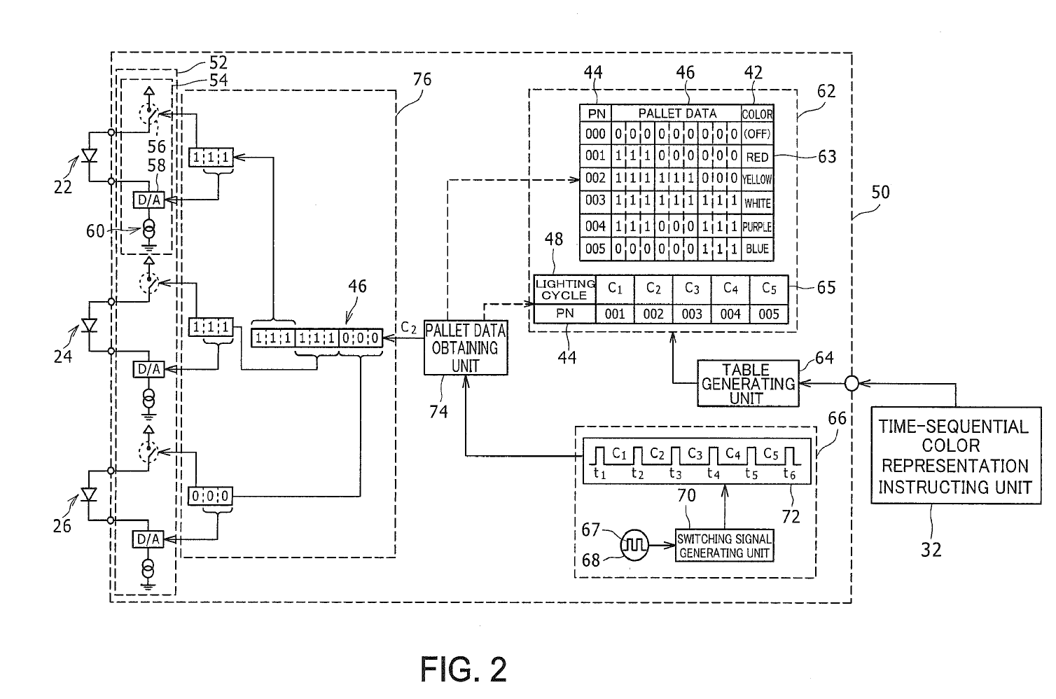

FIG. 1 is a block diagram for explaining a structure of a display driving system 10 including a display driving circuit 50 connected to one display channel unit 20. FIG. 2 is a diagram for explaining a detailed structure of the display driving system 10.

The display driving system 10 comprises a display channel unit 20 having 3 display devices which can display in different colors from each other, a display driving circuit 50 which is connected to the display channel unit 20 and which drives the display devices, and a control circuit 30 which provides a time-sequential color representation instruction to the display driving circuit 50. The display driving system 10 is a system having functions to set a driving condition of each display device according to the time-sequential color representation instruction and to display a desired time-sequential color representation. The display driving system is equipped on and used in, for example, a mobile device.

3 display devices of the display channel unit 20 are a red LED 22, a green LED 24, and a blue LED 26. As the LED, a structure which is mounted on a substrate in the form of a semiconductor chip and covered with a resin of a suitable lens shape may be used. Alternatively, an individual component with a lens or the like may be used.

The control circuit 30 is a circuit which controls the overall operation of the display driving system 10, and here, particularly includes a time-sequential color representation instructing unit 32. The time-sequential color representation instructing unit 32 has a function to provide a time-sequential color representation instruction to be displayed using the 3 display devices of the display channel unit 20 to the display driving circuit 50. As the control circuit 30, a microcomputer or the like which is a control device suited for equipment on a mobile device or the like may be used.

The time-sequential color representation refers to a configuration where a color representation displayed as a whole by combining the driving conditions of the 3 LEDs is changed in a time-sequential manner. For example, in 3 LEDs, a display of red color is achieved when only the red LED 22 is driven, a display of green color is achieved when only the green LED 24 is driven, and a display of blue color is achieved when only the blue LED 26 is driven. In addition, by simultaneously driving a plurality of LEDs, other color representations may be displayed. For example, a display of yellow color is achieved when the red LED 22 and the green LED 24 are simultaneously driven, and a display of purple color is achieved when the red LED 22 and the blue LED 26 are simultaneously driven. Furthermore, a display of white color is achieved when all of the red LED 22, green LED 24, and blue LED 26 are simultaneously driven.

In the time-sequential color representation, these plurality of types of color representations are arranged in time sequence. For example, after display of red color, display of yellow color may be achieved, and then, display of white color may be achieved. In addition, display of purple color may be subsequently achieved, and then, display of blue color may be achieved. In a mobile device or the like, when certain information is to be notified to the user, it is easier to catch the attention of the user by displaying with color representations of mixed colors such as yellow, white, and purple than by displaying with color representation of one basic color of red, green, and blue. In addition, by sequentially displaying a plurality of different color representations in a time sequential manner, the user's attention can be more easily caught. In these cases, the display of the time-sequential color representation is used.

The display driving circuit 50 connected to the display channel unit 20 and the control circuit 30 is an IC formed with one semiconductor chip. The display driving circuit 50 has a function to set the driving condition of a channel driving unit 52 in a time-sequential manner according to an instruction from the time-sequential color representation instructing unit 32 of the control circuit 30.

Specifically, the display driving circuit 50 comprises a channel driving unit 52 which drives three display devices of the display channel unit 20, a table generating unit 64 which, based on pallet data 46, details of which will be described later, generates a table necessary for channel driving according to the time-sequential color representation instruction instructed from the control circuit 30, a table storage unit 62 which stores the generated table, a cycle switching unit 66 which sequentially switches the lighting cycle, a pallet data obtaining unit 74 which refers to the stored table and obtains the pallet data 46 for each lighting cycle, and a pallet data setting unit 76 which assigns the obtained pallet data 46 while sequentially switching the pallet data 46 according to switching of the lighting cycle and sets the driving condition of the channel driving unit 52.

Of these elements, the functions other than that of the channel driving unit 52 can be realized with software. More specifically, these functions can be realized by executing corresponding display driving programs. As described, the display driving circuit 50 is an IC including a CPU which executes programs for realizing these functions. Alternatively, some or all of these functions may be realized with hardware. For example, the cycle switching unit 66 may be formed with a logic circuit.

The table generating unit 64 has a function to generate a table necessary for channel driving according to the time-sequential color representation instruction instructed by the time-sequential color representation instructing unit 32 of the control circuit 30 in advance, based on a plurality of types of pallet data 46 correlating a channel driving condition which is a driving condition of each display device of the display channel unit and each type of color representation. Specifically, as shown in FIG. 2, the table generating unit 64 has a function to generate a pallet data table 63 associating the pallet data 46 correlated to a color representation 42 and a pallet number (PN) 44, and a time-sequential pallet number table 65 associating an order of a lighting cycle 48 and the pallet number (PN) 44. In the following, a relationship or the like among the time-sequential color representation instruction, the color representation 42, the pallet data 46, the pallet data table 63, and the time-sequential pallet number table 65 will be described.

As described above, the time-sequential color representation instruction from the time-sequential color representation instructing unit 32 is an instruction arranging a plurality of types of color representations in the time-sequence. In FIG. 2, an example case is shown in which the color representation is switched in the order of red, yellow, white, purple, and blue every time the lighting cycle is switched. This time-sequential color representation includes information instruction corresponding to a movement of the color representation on the time axis which changes in a time-sequential manner, such as switching of the lighting cycle, and an information instruction of color such as red, yellow, white, purple, and blue.

These two information instructions can be defined independently from each other while linking the information instructions using the pallet number (PN) 44 in the following manner. The information instruction corresponding to the movement of the color representation on the time axis is provided with the order of the lighting cycle 48 and the pallet number (PN) 44, and the information instruction of the color is provided with the color representation 42, the pallet data 46, and the pallet number (PN) 44. With such a configuration, the two information instructions can be defined independently from each other while linking the information instructions with the pallet number (PN) 44. In this manner, the time-sequential color representation instruction is managed in a separated manner to the pallet data 46 correlated to the color representation and the information representing the movement of the color representation on the time axis.

These correlations are conveniently formed into tables. The time-sequential pallet number table 65 is a table showing the former correlation between the order of the lighting cycle 48 and the pallet number (PN) 44, and the pallet data table 63 is a table showing the latter correlation between the pallet data 46 correlated to the color representation 42 and the pallet number (PN) 44. FIG. 2 shows that these tables are generated by the table generating unit 64 according to the information instruction from the time-sequential color representation instructing unit 32 and that the generated tables are stored in the table storage unit 62.

As described, the pallet number (PN) 44 links the time-sequential pallet number table 65, which is a table of the time-sequential information instruction, and the pallet data table 63, which is a table of the color information instruction. When a certain pallet number (PN) 44 is selected, corresponding pallet data 46 is uniquely determined by referring to the pallet data table 63.

The pallet data 46 uniquely determined by the pallet number (PN) 44 is data correlating the channel driving condition which is a driving condition of each display device of the display channel unit 20 and each type of color representation.

In the following, the color representation 42 is shown in the figures in the pallet data table 63 in order to facilitate explanation of the relationship with the color representation 42, but the item of color representation 42 is not a necessary item in the pallet data table 63. The pallet data 46 is correlated to the color representation 42, but the correlation between the color representation 42 and the pallet data 46 only needs to be explicitly or implicitly defined in the table generating unit 64, and it is only necessary that the color representation 42 is converted into the pallet data 46 by the table generating unit according to the contents of the time-sequential color representation instruction and output to the pallet data table. Therefore, in the tale storage unit 62 and the pallet data setting unit 76 or the like, the pallet data 46 is the important information, and information of which color representation 42 the pallet data 46 is correlated to is not a necessary item.

As shown in the pallet data table 63 in FIG. 2, the pallet data 46 is data of 9 bits. In the 9-bit data, 3 bits are assigned as a driving condition of the red LED 22, 3 bits are assigned as a driving condition of the green LED 24, and 3 bits are assigned as a driving condition of the blue LED 26.

That is, the driving condition of each LED is represented with 3 bits. In the 3 bits as the driving condition of each LED, 1 bit is assigned as the ON-OFF data and 2 bits are assigned as grayscale data. Therefore, for each LED, a total of 5 driving conditions, including an OFF state and 4 grayscales in the ON state, are shown by the pallet data 46.

As described, because each pallet data 46 is data which represents the ON-OFF state of each LED and the grayscale state of the LED, the pallet data 46 is also data indicating a type of color representation displayed on the display channel unit 20 in which the red LED 22, the green LED 24, and the blue LED 26 are combined into a group.

In FIG . 2, PN001 is correlated to pallet data 46 of (111000000). This data corresponds to a red color representation because only the red LED 22 is switched ON, with a full grayscale state. PN002 is correlated to pallet data 46 of (111111000), which corresponds to a yellow color representation because the red LED 22 and green LED 24 are switched ON, with a full grayscale state. Similarly, PN003 is correlated to pallet data 46 of (111111111), which corresponds to the white color representation because the red LED 22, green LED 24, and blue LED 26 are switched ON, with a full grayscale state. PN004 is correlated to pallet data 46 of (111000111), which corresponds to purple, with the red LED 22 and the blue LED 26 being in the full grayscale state, and PN005 is correlated to pallet data 46 of (000000111), which corresponds to blue in which only the blue LED 26 is in the full grayscale state.

As described, the pallet data 46 is data of a channel driving condition which is a driving condition of the red LED 22, the green LED 24, and the blue LED 26 of the display channel unit 20. In other words, the pallet data 46 is data correlating the channel driving condition, which is a driving condition of each display device of the display channel unit 20, and each type of color representation.

As shown in FIG. 2, the time-sequential pallet number table 65 is a table correlating the order of the lighting cycle 48 and the pallet number. Specifically, in FIG. 2, a pallet number (PN) 44 of PN001 is assigned to a lighting cycle C₁, and a pallet number (PN) 44 of PN002 is assigned to a lighting cycle C₂. Similarly, PN003 is assigned to a lighting cycle C₃, PN004 is assigned to a lighting cycle C₄, and PN005 is assigned to a lighting cycle C₅.

When the pallet data table 63 is referred to through the pallet number (PN) 44, it is possible to obtain pallet data 46 assigned to each lighting cycle 48. For example, in the lighting cycle C₁ of FIG. 2, PN001 is assigned as the pallet number (PN) 44, and because PN001 corresponds to the pallet data 46 of (111000000) which is the red color representation, it can be understood that the pallet data 46 for representing red is assigned to the lighting cycle C.

Similarly, in FIG. 2, because PN002 is assigned to C₂, PN003 is assigned to C₃, PN004 is assigned to C₄, and PN005 is assigned to C₅, the pallet data 46 of (111111000) which is the yellow color representation is assigned to PN002, the pallet data 46 of (111111111) which is the white color representation is assigned to PN003, the pallet data 46 of (111000111) which is the purple color representation is assigned to PN004, and the pallet data 46 of (000000111) which is the blue color representation is assigned to PN005.

As described above, the table generating unit 64 has a function to receive the instruction of the time-sequential color representation instructing unit 32 and, in accordance with the contents of the instruction, generate the pallet data table associating the color representation 42, the pallet data 46, and the pallet number (PN) 44, and the time-sequential pallet number table 65 associating the order of the lighting cycle 48 and the pallet number (PN) 44. The table is generated or updated at a suitable timing based on the instruction of the time-sequential color representation instructing unit 32.

The pallet data table 63 and the time-sequential pallet number table 65 generated in this manner are stored in the table storage unit 62. As the table storage unit 62, a suitable memory may be used.

The cycle switching unit 66 has a function to switch the lighting cycle sequentially to a next lighting cycle every time the lighting period of the lighting cycle elapses. A signal for switching the lighting cycle sequentially to the next lighting cycle is shown in FIG. 2 as a switching signal 72. The cycle switching unit 66 comprises a clock signal generating unit 68 and a switching signal generating unit 70.

As shown in FIG. 2, the switching signal 72 comprises a switching pulse to set a period of the lighting cycle C₁ at time t₁, a switching pulse to set a period of the lighting cycle C₂ at time t₂, a switching pulse to set the lighting cycle C₃ at time t₃, a switching pulse to set a period of the lighting cycle C₄ at time t4, a switching pulse to set a period of the lighting cycle C₅ at time t₅, and a switching pulse to complete the lighting cycle C₅ and set a period of a next lighting cycle at time t₆.

The switching signal generating unit 70 is a circuit having a function to generate the switching signal 72 based on a clock signal 67 which is output from the clock signal generating unit 68. That is, the switching pulse of the switching signal is generated as a pulse for each switching period in units of the clock period of the clock signal 67 which is output from the clock signal generating unit 68 and corresponding to the lighting period of each lighting cycle. For example, when the switching period is CT and the clock period is t_{ck}, the switching pulse is output when a number of pulses of n=CT/t_{ck} is counted. Thus, the switching signal generating unit 70 is a circuit having a pulse counting function.

For the lighting cycles, CT may be the same or different. In the former case, the same CT is repeated in the lighting cycles C₁ through C₅, and in the latter case, the CT may be set to different CTs such as the CT of the lighting cycle C₁ being different from the CT of the lighting cycle C₂, or the CT of the lighting cycle C₂ being different from the CT of the lighting cycle C₃.

The pallet data obtaining unit 74 has a function to refer to the pallet data table 63 and the time-sequential pallet number table 65 stored in the table storage unit 62, to sequentially obtain the pallet data 46 corresponding to each lighting cycle 48, and send the pallet data 46 to the next pallet data setting unit 76.

The pallet data setting unit 76 has a function to assign the obtained pallet data 46 to the corresponding lighting cycle 48 while sequentially switching the pallet data 46 according to the switching of the lighting cycle 48, and set the driving conditions of the display devices 22, 24, and 26 of the display channel unit 20.

In the example configuration of FIG. 2, the lighting cycle C₁ is correlated to PN001, and PN001 is correlated to the pallet data 46 of (111000000). Thus, a driving condition having only the red LED 22 at the full grayscale state is assigned to the display devices of the display channel unit 20 in the lighting cycle C₁. When the lighting cycle is next switched to the lighting cycle C₂ by the lighting cycle switching of the cycle switching unit 66, because the lighting cycle C₂ is correlated to PN002 and PN002 is correlated to the pallet data 46 of (111111000), a driving condition having the red LED 22 and the green LED 24 at the full grayscale state is assigned to the display devices of the display channel unit 20 in the lighting cycle C₂.

In this manner, based on the pallet data time-sequential table 65, when the lighting cycles change in the order of C₁, C₂, C₃, C₄, and C₅, the driving conditions of (111000000) , (111111000), (111111111), (111000111), and (1000000111) are assigned to the display channel unit 20 as the lighting cycle is sequentially switched.

The channel driving unit 52 is a collection of driving circuits 54 each of which drives the red LED 22, the green LED 24, and the blue LED 26, which are display devices of the display channel unit 20. The driving circuit 54 is connected to both terminals of one LED, and comprises an ON-OFF switch element 56 provided between an anode terminal of the LED and a power supply terminal, and a D/A converter 58 provided between a cathode terminal of the LED and a constant current source 60. The D/A converter 58 is a circuit which converts 2-bit digital data into analog data, and has a function to adjust the current value flowing in the LED from the full-range current value of the constant current source 60 to ¼ of the full-range current value of the constant current source 60.

FIG. 2 shows that the pallet data 46 assigned to the lighting cycle C₂ is set as the driving condition of the channel driving unit 52. In other words, the pallet data 46 assigned to the lighting cycle C₂ by the pallet data table 63 and the time-sequential pallet number table 65 is PN002, and the 9-bit data of the pallet data 46 is (111111000). PN002 corresponds to the yellow color representation.

Here, the first 3-bit data of the 9-bit data, (111), corresponds to the driving condition of the red LED 22, the next 3-bit data, (111), corresponds to the driving condition of the green LED 24, and the last 3-bit data, (000), corresponds to the driving condition of the blue LED 26.

In consideration of this, the first 3-bit data, (111), is set as the driving condition of the driving circuit 54 for the red LD 22 of the channel driving unit 52. That is, the first 1-bit data of (111) is set as the data defining the ON-OFF state of the ON-OFF switch element 56 and the next 2-bit data is set as data defining an operation state of the 2-bit D/A converter 58. In this example configuration, the ON-OFF switch element 56 is set to the ON state, and the D/A converter 58 is set to a state where a full-range current value of the constant current source 60 is applied to the red LED 22. In other words, the red-LED 22 is set to the fully lighted state.

Similarly, the next 3-bit data, (111), is set for the driving circuit 54 for the green LED 24 as the driving condition of the green LED 24. In this case also, similar to the driving state of the red LED 22, the green LED 24 is set to the fully lighted state.

The last 3-bit data, (000), corresponds to the driving condition of the blue LED 26. Because the first 1-bit is 0, the ON-OFF switch element 56 of the driving circuit 54 for the blue LED 26 is set to the OFF state. Therefore, the blue LED 25 is in the OFF state and is set to a non-lighted state.

In this manner, the pallet data 46 of (111111000) is set as the driving condition of the channel driving unit 52, and in the above-described example configuration, the red LED 22 and the green LED 24 are set to the fully lighted state corresponding to the full grayscale state, and the blue LED 26 is set to the non-lighted state. In this manner, the display channel unit 20 displays the yellow color representation as a whole in the lighting cycle C₂.

Similarly, the pallet data table 63 and the time-sequential pallet number table 65 shown in FIG. 2 are referred to, each pallet data 46 is assigned to each lighting cycle, and according to the assignment, the driving conditions of the red LED 22, the green LED 24, and the blue LED 26 are set in the channel driving unit 52. As a result, the display channel unit 20 sequentially achieves the display of red in the lighting cycle C₁, the display of yellow in the lighting cycle C₂, the display of white in the lighting cycle C₃, the display of purple in the lighting cycle C₄, and the display of blue in the lighting cycle C₅.

In this manner, the table generating unit 64 generates the pallet data table 63 and the time-sequential pallet number table 65 according to the instruction of the time-sequential color representation instructing unit 32, and the tables are stored in the table storage unit 62. When the pallet data 46 is sent to the pallet data setting unit 76, the pallet data obtaining unit 74 obtains the switching timing from the cycle switching unit 66 and the order information of the lighting cycles 48 to be displayed, refers to the time-sequential pallet number table 65, and obtains the pallet number (PN) 44 for each lighting cycle 48. Then, the pallet data obtaining unit 74 refers to the pallet data table 63 and obtains the pallet data 46 corresponding to the obtained pallet number (PN) 44. The pallet data 46 obtained in this manner is sent to the pallet data setting unit 76.

In this manner, each pallet data 46 is time-sequentially set in correspondence to the time-sequential color representation instruction to the channel driving unit 52 which drives the display devices of the display channel unit 20. The pallet data 46 is a driving condition of the plurality of display devices correlated to the color representation when the time-sequential color representation is realized, and is independent from the time sequence. Therefore, even when the lighting color change pattern indicating the time-sequential color representation is to be changed, it is only required to replace the pallet data 46 or rewrite the contents thereof, and it is not necessary to change the entire time-sequential driving conditions of the display devices. Therefore, a variety of color representations using the plurality of display devices which can display in different colors from each other can be easily set.

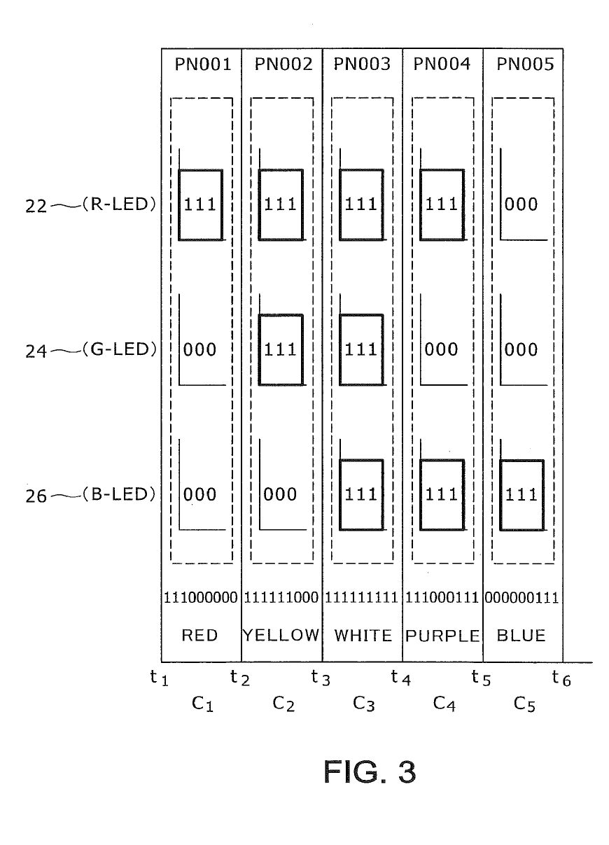

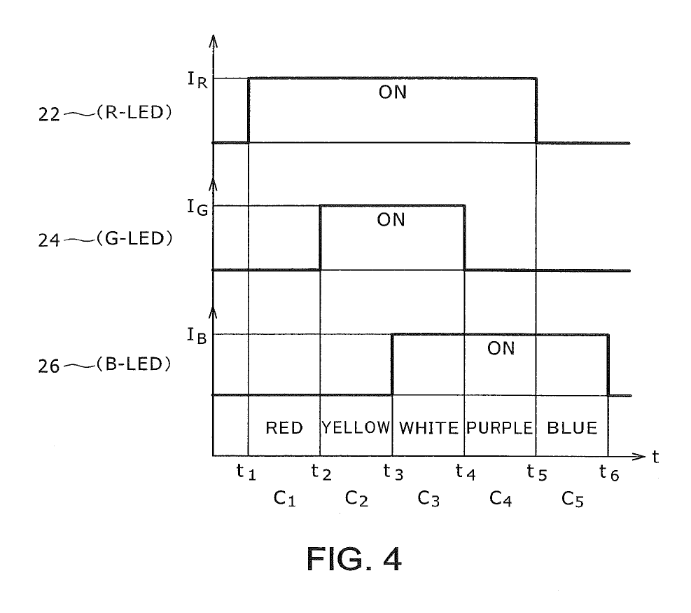

An operation and advantage of the above-described structure will now be described with reference to FIG. 3. For the purpose of comparison, FIG. 4 shows the lighting control when the same time-sequential color representation is realized in the related art. Here, an example configuration is described in which the control circuit 30 provides a time-sequential color representation instruction “to time-sequentially display red from time t₁ to time t₂, yellow from time t₂ to time t₃, white from time t₃ to time t₄, purple from time t₄ to time t₅, and blue from time t₅ to time t₆” to the display driving circuit 50.

The time-sequential pallet data 46 corresponding to the time-sequential color representation has a content provided by the pallet data table 63 and the time-sequential pallet number table 65 of FIG. 2. Therefore, in the lighting cycle C₁, from time t₁ to time t₂ instructed as the red display, (111000000) which is PN001 is set as the pallet data 46 for the driving condition of the channel driving unit 52. FIG. 3 shows this configuration with (111) being set in the driving circuit 54 for the red LED 22, (000) being set. in the driving circuit 54 for the green LED 24, and (000) being set in the driving circuit 54 for the blue LED 26 between time t₁ and time t₂.

For the case of the lighting cycle C₂ from time t₂ to time t₃ instructed as yellow display, as already described as an example in FIG. 2, (111111000) which is PN002 is set as the pallet data 46 for the driving condition of the channel driving unit 52. FIG. 3 shows this configuration with (111) being set in the driving circuit 54 for the red LED 22, (111) being set in the driving circuit 54 for the green LED 24, and (000) being set in the driving circuit 54 for the blue LED 26 between time t₂ and time t₃.

Similarly, in the lighting cycle C₃ from time t₃ to time t₄ instructed as white display, (111111111) which is PN003 is set as the pallet data 46 for the driving condition of the channel driving unit 52. FIG. 3 shows this configuration with (111) being set in the driving circuit 54 for the red LED 22, (111) being set in the driving circuit 54 for the green LED 24, and (111) being set in the driving circuit 54 for the blue LED 26 between time t₃ and time t₄.

In the lighting cycle C₄ between time t₄ and time t₅ instructed as the purple display, (111000111) which is PN004 is set as the pallet data 46 for the driving condition of the channel driving unit 52. FIG. 3 shows this configuration with (111) being set in the driving circuit 54 for the red LED 22, (000) being set in the driving circuit 54 for the green LED 24, and (111) being set in the driving circuit 54 for the blue LED 26 between time t₄ and time t₅.

Further, in the lighting cycle C₅ from time t₅ to time t₆ instructed as blue display, (000000111) which is PN005 is set as the pallet data 46 for the driving condition of the channel driving unit 52. FIG. 3 shows this configuration with (000) being set in the driving circuit 54 for the red LED 22, (000) being set in the driving circuit 54 for the green LED 24, and (111) being set in the driving circuit 54 for the blue LED 26 between time t₅ and time t₆.

In this manner, in the channel driving unit 52 which drives the display devices of the display channel unit 20, pallet data 46 provided through the pallet number (PN) 44 between the pallet data table 63 and the time-sequential pallet number table 65 are time-sequentially set. With this configuration, color representation according to the time-sequential color representation instruction from the control circuit 30 is displayed on the display channel unit 20 according to the time sequence.

As can be understood from FIG. 3, the pallet data 46 is the driving conditions of the plurality of display devices correlated to the color representations when the time-sequential color representation is realized, and is independent from the time sequence. Therefore, the change of the lighting color change pattern representing the time-sequential color representation can be easily realized by replacing the pallet data 46 or rewriting the contents thereof.

For example, even when it become necessary to interchange the yellow and blue in the above-described time-sequential color representation instruction from the control device 30, it is only necessary to replace the pallet number (PN) 44 in the lighting cycle C₂ in the time-sequential pallet number table 65 from PN002 to PN005 and replace the pallet number (PN) 44 in the lighting cycle C₅ from PN005 to PN002. Alternatively, the pallet number (PN) 44 corresponding to the lighting cycle in the time-sequential pallet number table 65 may be left untouched, and the contents of PN002 in the pallet data table 63 may be rewritten from (111111000) to (000000111) and the contents of PN005 may be rewritten from (000000111) to (111111000).

FIG. 4 is a diagram showing a lighting control of related art. For comparison purposes, a case is shown in which the same time-sequential color representation as in FIG. 3 is realized. In the related art, in order to obtain a desired color representation, the lighting controls of the red LED 22, the green LED 24, and the blue LED 26 are separately executed. For example, when the time-sequential color representation instruction to “time-sequentially display red between time t₁ and time t₂, yellow from time t₂ to time t₃, white from time t₃ to time t₄, purple from time t₄ to time t₅, and blue from time t₅ to time t₆” as described above is provided, the contents are decomposed into a lighting pattern which is the ON-OFF pattern for the driving circuit for the red LED 22, a lighting pattern for the driving circuit for the green LED 24, and a lighting pattern for the driving circuit for the blue LED 26.

Specifically, as shown in FIG. 4, for the red LED 22, a lighting pattern is set in which the red LED 22 is switched ON from time t₁ to time t₅, for the green LED 24, a lighting pattern is set in which the green LED 24 is switched ON from time t₂ to time t₄, and for the blue LED 26, a lighting pattern is set in which the blue LED 26 is switched ON from time t₃ to time t₆.

As described, in the related art, the lighting pattern for the red LED 22, the lighting pattern for the green LED 24, and the lighting pattern for the blue LED 26 are set according to the desired time-sequential color representation. If the desired time-sequential color representation continues to be used, the setting will also continue to be used without a change. On the other hand, when the time-sequential color representation is to be changed for any reason, all of the lighting pattern for the red LED 22, the lighting pattern for the green LED 24, and the lighting pattern for the blue LED 26 must be changed.

The exemplified change of the time-sequential color representation described above with reference to FIG. 3 would be achieved in the related art of FIG. 4 in the following manner. Because the yellow and blue are to be interchanged, the setting of the lighting pattern for the red LED 22 is changed to ON from time t₁ to time t₂, OFF from time t₂ to time t₃, and ON from time t₃ to time t₆. The setting of the lighting pattern for the green LED 24 is changed to ON from time t₃ to time t₄ and from time t₅ to time t₆, and OFF in other periods. The setting of the lighting pattern for the blue LED 26 is changed to ON from time t₂ to time t₅. As described, the interchanging of yellow and blue which appears simple requires changes of settings of all lighting patterns of all LEDs.

In the above description, an example configuration has been described in which the number of display channel units is 1. Alternatively, the number of display channel units may be 2 or greater. In this case, as the number of display devices is increased with the increase in the number of display channel units, color representations with more variety may be enabled. With the use of the pallet data 46, the driving condition of each display channel unit corresponding to the variety of color representations can be easily set, and the change of the color representation can be flexibly handled.

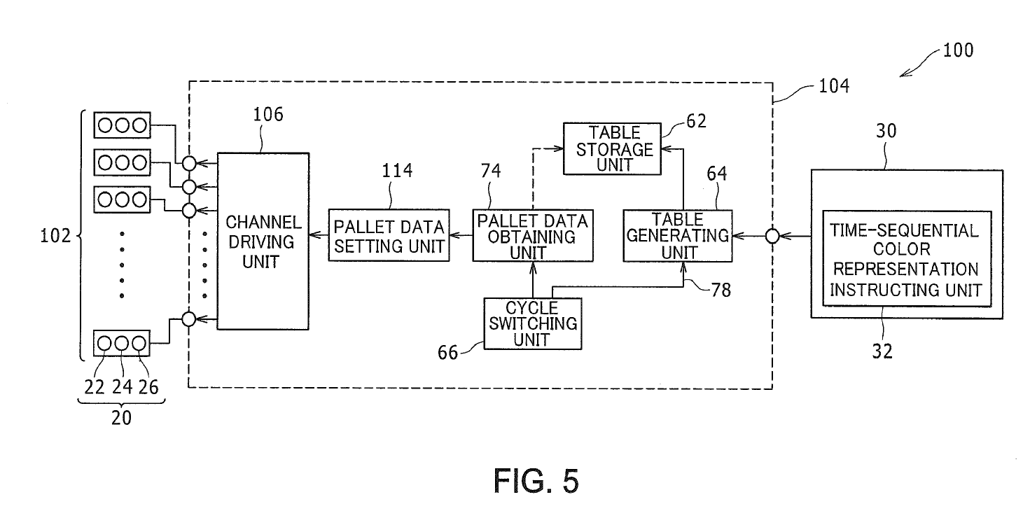

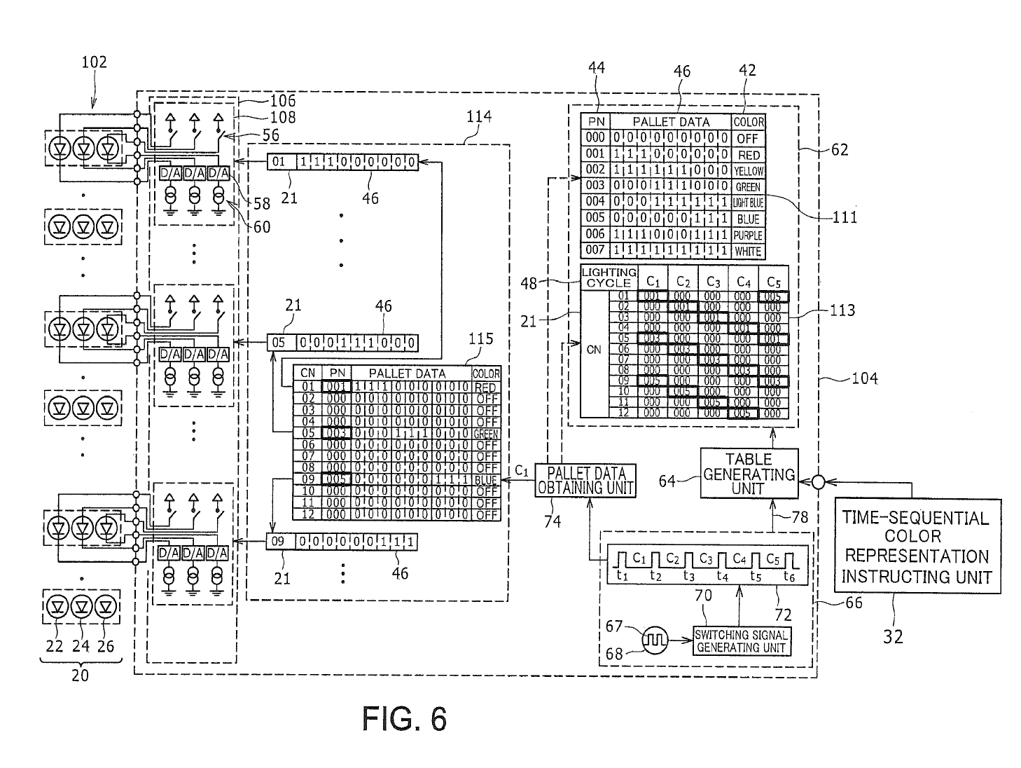

FIG. 5 is a block diagram showing a structure of a display driving system 100 including a display driving circuit 104 connected to a display channel unit group 102 having 12 display channel units 20. FIG. 6 is a diagram for explaining a detailed structure of the display driving system 100.

As shown in FIG. 6, a channel driving unit group 106 having 12 groups of channel driving units 108 is provided corresponding to the 12 groups of display channel units 20. The channel driving units 108 have a similar structure to the channel driving unit 52 described above with reference to FIG. 2, and include 3 ON-OFF switch elements 56, 3 D/A converters 58, and 3 constant current sources 60 as a driving circuit corresponding to the red LED 22, a driving circuit corresponding to the green LED 24, and a driving circuit corresponding to the blue LED 26.

In this case, from the time-sequential color representation instructing unit 32 of the control circuit 30, a time-sequential color representation instruction is provided for each of the 12 groups of display channel units 20. In order to distinguish among the 12 groups of display channel units 20, a channel unit number (CN) 21 will be used, and display channel units 20 are indicated by CN01 through CN12. In the example configuration of FIG. 6, a case is exemplified where it is instructed that 3 colors of red, green and blue are sequentially displayed while the intervals are maintained constant by lighting and extinguishing the 12 groups of display channel units 20.

Specifically, in a lighting cycle C₁, CN01 is set to red, CN02-CN04 are set to extinguished, that is, OFF, CN05 is set to green, CN06-CN08 are set to OFF, CN09 is set to blue, and CN10-CN12 are set to OFF. In a lighting cycle C₂, the channel unit number is advanced by one for the lighting and the OFF state to set CN01 to OFF, CN02 to red, CN03-CN05 to OFF, CN06 to green, CN07-CN09 to OFF, CN10 to blue, and CN11 and CN12 to OFF. Subsequently, the channel unit number is advanced by 1 for the lighting and the OFF state as the lighting cycle 48 is advanced by 1, in a manner similar to the above. In this manner, red, green, and blue are displayed in a flowing manner along the channel unit numbers (CN) 21.

The table generating unit 64 has a function to generate a pallet data table 111 and a time-sequential pallet number table 113 in correspondence with such an instruction. In FIG. 2, because the number of display channel units 20 is 1, it is only necessary to correlate the pallet number (PN) 44 to each lighting cycle 48. Here, on the other hand, the pallet number (PN) 44 must be correlated for each lighting cycle 48 and for each of the channel unit numbers (CN) 21 distinguishing the 12 groups of display channel units 20.

In FIG. 6, the pallet data table 111 is shown with 8 types of OFF, red, blue, green, light blue, blue, purple, and white assigned as color representations 42 to pallet numbers (PN) 44 of PN000 to PN007. In the above-described color representation instruction, of these color representations, OFF represented with (000000000) which is PN000, red represented with (111000000) which is PN001, green represented by (000111000) which is PN003, and blue represented by (000000111) which is PN005 are actually used.

The time-sequential pallet number table 113 associates the channel unit number (CN) 21 for each order of the lighting cycle 48 and the pallet number (PN) 44. For example, for the lighting cycle C₁, for each of the 12 channel unit numbers (CN) 21 from CN01 to CN12, a pallet number (PN) 44 corresponding to the time-sequential color representation instruction is assigned. In the above-described example configuration, PN001 is assigned to CN01, PN000 is assigned to CN02 to CN04, PN003 is assigned to CN05, PN000 is assigned to CN06 to CN08, PN005 is assigned to CN09, and PN000 is assigned to CN10 to CN12.

Similarly, in the lighting cycle C₂, the lighting and OFF states in the lighting cycle C₁ are advanced by one in the channel unit number (CN) 21, such that PN000 is assigned to CN01, PN001 is assigned to CN02, PN000 is assigned to CN03 to CN05, PN003 is assigned to CN06, PN000 is assigned to CN07 to CN09, PN005 is assigned to CN10, and PN000 is assigned to CN11 and CN12. Subsequently, the channel unit number for the lighting and OFF states is advanced by 1 as the lighting cycle 48 is advanced by 1, in a manner similar to the above. In this manner, the time-sequential pallet number table 113 is generated.

The generated pallet data table 111 and the generated time-sequential pallet number table 113 are stored in the table storage unit 62. The pallet data obtaining unit 74 has a function to refer to the stored pallet data table 111 and the stored time-sequential pallet number table 113, and obtain pallet data 46 corresponding to each channel unit number 21 for each lighting cycle 48.

The pallet data setting unit 114 assigns the 12 pallet data 46 obtained for the switched lighting cycle 48 to each display channel driving unit 108. At the time when the lighting cycle 48 is switched next, the pallet data setting unit 114 assigns the 12 pallet data 46 obtained for the switched lighting cycle 48 to each display channel driving unit 108, and repeats this process. In this manner, the pallet data setting unit 114 has a function to assign the obtained pallet data 46 by sequentially switching the pallet data 46 according to the switching of the lighting cycle 48, and to set the driving conditions of the display devices 22, 24, and 26 of the 12 groups of display channel units 20.

When the group of pallet data 46 corresponding to the channel unit numbers 21 for each lighting cycle 48 is called a pallet data group, FIG. 6 shows a pallet data group 115 assigned to the lighting cycle C₁. The pallet data group 115 is the contents of the pallet data 46 corresponding to the 12 channel unit numbers 21 in the lighting cycle C₁ in the pallet data obtaining unit 74. When the contents of the pallet data group 115 are sent to the pallet data setting unit 114, the driving conditions are set in the channel driving units 108 according to the contents thereof.

Specifically, (111000000) is assigned to CN01 as the pallet data 46, (000000000) is assigned to CN02 to CN04 as the pallet data 46, (000111000) is assigned to CN05 as the pallet data 46, (000000000) is assigned to CN06 to CN08 as the pallet data 46, (000000111) is assigned to CN09 as the pallet, data 46, and (000000000) is assigned to CN10 to CN12 as the pallet data 46.

For example, the pallet data 46 of CN01, (111000000), is assigned to the first channel driving unit 108 corresponding to the first display channel unit 20. The pallet data 46 corresponds to the red color representation.

The 9 bits of the pallet data 46 assigned to CN01, (111000000), are set as the ON-OFF data of the 3 ON-OFF switch elements 56 and the grayscale data of the 3 D/A converter 58 of the first channel driving unit 108 in a manner similar to that already described above with reference to FIG. 2. In this case, the driving conditions are set such that the red LED 22 is fully lighted and the green LED 24 and the blue LED 26 are extinguished.

Similarly, the pallet data 46 of CN05, (000111000), is assigned to a fifth channel driving unit 108 corresponding to a fifth display channel unit 20. In this case, the driving conditions are set such that the green LED 24 is fully lighted and the red LED 22 and the blue LED 26 are extinguished. In addition, the pallet data 46 of CN09, (000000111) is assigned to a ninth channel driving unit 108 corresponding to a ninth display channel unit 20. In this case, the driving conditions are set such that the blue LED 26 is fully lighted and the red LED 22 and the green LED 24 are extinguished. For the other CN numbers, pallet data 46 of (000000000) is assigned, and thus driving conditions are set such that the corresponding display devices 22, 24, and 26 are all extinguished.

In this manner, 12 pallet data 46 forming a part of the pallet data group 115 assigned to the lighting cycle C₁ are set as driving conditions of the 12 channel driving units 108. In addition, for the other lighting cycles also, when the lighting cycle is switched, 12 pallet data 46 of the pallet data group 115 assigned to the lighting cycle are set as driving conditions in the 12 channel driving units 108.

As described, the pallet data 46 is the driving conditions of the plurality of display devices correlated to color representation when the time-sequential color representation is realized, and is independent from the time sequence. Therefore, even when the lighting color change pattern representing the time-sequential color representation is to be changed, it is only necessary to replace the pallet data 46 or rewrite the contents of the pallet data 46, and it is not necessary to change all of the time-sequential driving conditions of the display devices. In relation to FIG. 2, a case when it becomes necessary to interchange yellow and blue in the time-sequential color representation instruction has been described. In the case of FIG. 6 also, similar to this case, the lighting color change pattern representing the time-sequential color representation can be changed by changing the pallet data 46.

With regard to the time-sequential color representation provided from the time-sequential color representation instructing unit 32, the pallet data table 111 and the time-sequential pallet number table 113 which can be generated by the table generating unit 64 are not the only ones, and other generating methods may be employed. Other example configurations for the table generation other than the pallet data table 111 and the time-sequential pallet number table 113 described above with reference to FIG. 6 will now be described. The example configurations described below are merely exemplary, and the present invention is not limited to these example and other table generations are also possible.

In FIG. 6, in the pallet data table 111, all necessary colors are fixedly defined in advance, and the table generating unit 64 simply inverse-converts in one-to-one relationship a color in the time-sequential color representation instruction from the color representation 42 of the pallet data table 111 to determine the pallet number (PN) 44, executes this process for each lighting cycle 48 and for each channel number (CN) 21, and generates the time-sequential pallet number table 113.

In this configuration, because color representations for colors other than those defined in advance cannot be realized, the number of colors that can be represented is limited by the capacity of the pallet data table 111, that is, the number of types of the pallet numbers (PN) 44. As the number of types of the pallet numbers (PN) 44 is increased, the limitation on the number of colors that can be represented is reduced, and ultimately, the number of color representations that can be represented can be increased to 2⁹ pallet numbers. However, the storage capacity necessary for the table storage unit 62 would be correspondingly increased. In reality, in many cases, even if the number of lighting cycles 48 is large, a certain limited number of types of colors are repeatedly lighted in the plurality of display channel units 20. Therefore, when it is known that the number of colors that are actually used is small to a certain degree, the structure explained above with reference to FIG. 6 is simple, easy to understand, and has a small data size.

In the case of this configuration, for example, when all of the portions lighted in red are to be changed to green, 5 pallet numbers (PN) 44 including CN01-C₁, CN02-C₂, CN03-C₃, CN04-C₄, and CN05-C₅ in the time-sequential pallet number table 113 may be replaced from the value PN001 to the value PN003. However, because the table generating unit 64 inversely converts from the color representation 42 to the pallet number (PN) 44 using the pallet data table 111 when the table generating unit 64 generates the time-sequential pallet number table 113, the simple change of the pallet data 46 of PN001 of the pallet data table 111 to (000111000) and rewriting the color representation 42 to green is not permitted because the number of pallet numbers (PN) corresponding to the green color representation 42 becomes 2, that is, PN001 and PN003, and the unique inverse conversion cannot be executed. A reduction of brightness of red for the overall time-sequential color representation can be achieved, for example, by changing the pallet data 46 of PN001 in the pallet data table 111 to (110000000), and thus requires only one correction.

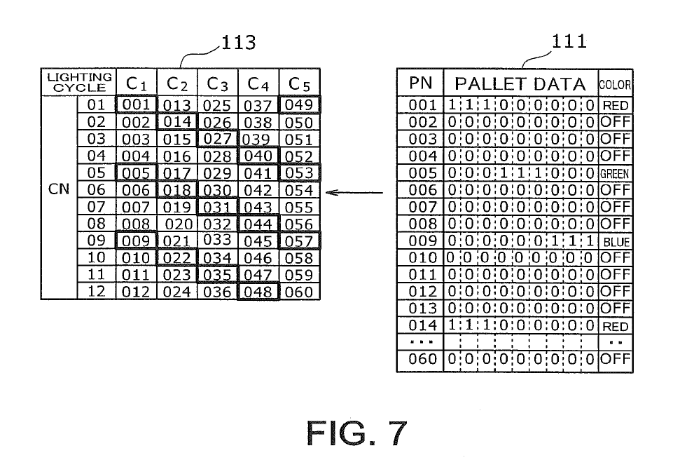

FIG. 7 is a diagram for explaining another example of table generation according to the color representation instruction. Here, pallet numbers (PN) 44 for all combinations calculated by the number of types of the lighting cycles 48 and the number of types of the channel unit numbers (CN) 21 are prepared. In the instruction for the time-sequential color representation described above with reference to FIG. 6, the number of lighting cycles 48 is 5 and the number of channel unit numbers (CN) 21 is 12. Therefore, the pallet table 111 is generated with 5×12=60 pallet numbers (PN) 44.

In the structure of FIG. 7, when the number of types of the lighting cycle 48 and the number of types of the channel unit number (CN) 21 are increased, the capacity of the pallet data table 111 is increased in proportion. In this structure, the order arrangement of the time-sequential pallet number table 113 is in the same data arrangement as the order arrangement of the pallet data table 111, and thus in the table generating unit 64, the process flow is to generate the pallet data table 111 according to the order of the time-sequential pallet number table 113. In this structure, the order arrangement of the time-sequential pallet number table 113 is practically uniquely determined when the number of types of the lighting cycles 48 and the number of types of the channel unit numbers (CN) 21 are determined. Therefore, it is also possible to employ a configuration where the time-sequential pallet number table 113 is not stored in the table storage unit 62 and is implicitly defined.

In the case of this structure, for example, when all of the portions lighted in red are to be changed to green, 5 pallet data 46 including PN001, PN014, PN027, PN040, and PN053 in the pallet data table 111 may be rewritten from (111000000) to (000111000). It should be noted that when the brightness of red is to be reduced by changing the pallet data 46 to (110000000) similar to the previous example structure, 5 pallet data 46 including PN001, PN014, PN027, PN040, and PN053 are corrected similar to the above, and the advantage of separating into the color information and the time-sequential movement information cannot be sufficiently obtained.

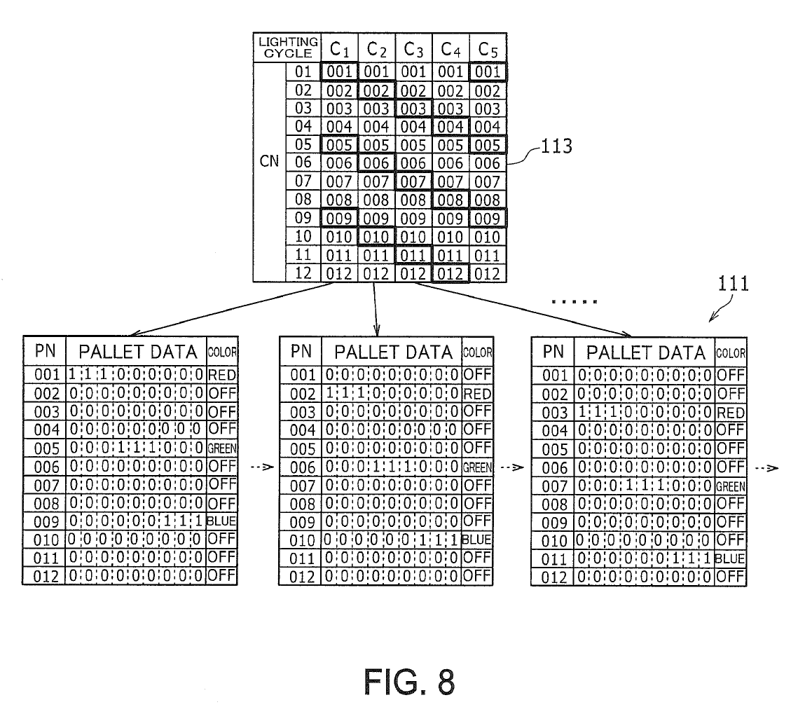

FIG. 8 is a diagram for explaining another example table generation according to the color representation instruction. Here, in order to avoid the capacity of the pallet data table 111 becoming too large in FIG. 7, the number of types of the pallet numbers (PN) 44 is set to the same or greater than the number of types of channel unit numbers (CN) 21, and the assignment of the pallet data table 111 is dynamically changed in synchronization with the switching of the lighting cycle 48. For this synchronization, a synchronization signal 78 is supplied from the cycle switching unit 66 to the table generating unit 64.

According to this structure, substantially, the information of the lighting cycles 48 of C₁, C₂, C₃, . . . becomes unnecessary in the time-sequential pallet number table 113, and the channel unit number (CN) 21=the pallet number (PN) 44. Therefore, the time-sequential pallet number table 113 itself becomes substantially unnecessary, and the structure is the same as if the time-sequential pallet number table 113 is implicitly defined. This structure has an advantage in that the storage capacity of the table storage unit 62 is reduced, but the information corresponding to the movement of the color representation is not stored and continued to be successively generated. Therefore, when the processing time for generating the next pallet data table 111 is long, in particular, in a representation having a fast movement, the updating of the pallet data table 111 may not be executed on time, and an unintended color representation may be realized.

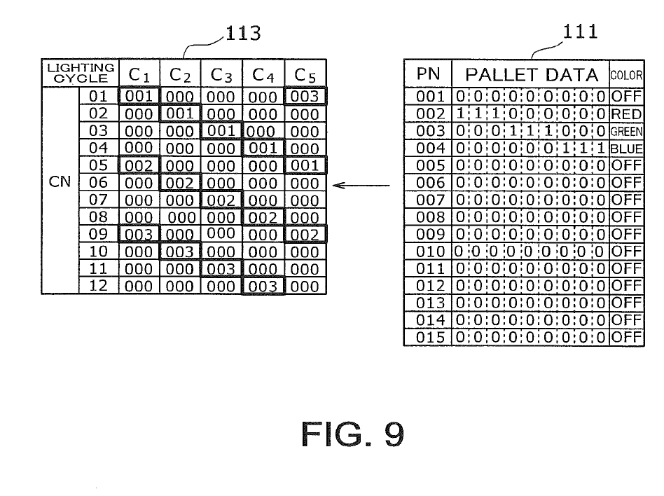

FIG. 9 is a diagram for explaining another example table generation according to the color representation instruction. Here, a few types of pallet numbers (PN) 44 are prepared in advance. In the example configuration of FIG. 9, PN000 is fixed at the extinguished state, that is, the OFF state, and the color representations other than the extinguished state appearing in the time-sequential color representation instruction are assigned in the order of color representation 1, color representation 2, color representation 3, . . . , and pallet numbers (PN) 44 are sequentially assigned as PN001, PN002, PN003, . . . every time a color representation of different type appears. In this manner, the information corresponding to the movement of the color is extracted from the time-sequential color representation instruction. Then, from the time-sequential color representation instruction, the color representations corresponding to PN001 which is the color representation 1, PN002 which is the color representation 2, PN003 which is the color representation 3, . . . are defined in the pallet data table 111.

In FIG. 9, red is assigned to PN001, green is assigned to PN002, and blue is assigned to PN003, sequentially. PN004 to PN015 are reserve pallet data regions, and are unused regions in the exemplified time-sequential color representation. In the case of other time-sequential color representations, there is a possibility of using the pallet numbers up to PN015. In FIG. 9, the pallet data 46 of the unused pallet number (PN) 44 is set to (000000000) representing the OFF state, but any pallet data 46 may be employed for the unused region.

In the structure of FIG. 9, a maximum number of types of color representations that can appear in a sequence of the time-sequential color representations is limited by the number of types of the pallet numbers (PN) 44 which is prepared in advance. Therefore, similar to the structure described above with reference to FIG. 6, in order to improve the representation capability, the number of types of the pallet numbers (PN) 44 must be increased. However, in reality, in a time-sequential color representation in which the same colors repeatedly appear, the capacity of the pallet data table 111 is not increased too much, and the configuration can be considered more preferable.

In addition, in the structure described above with reference to FIG. 6, definition in the pallet data table 111 is necessary for the number of types of color representations that need to be used. Therefore, yellow, light blue, purple, and white, which are color representations that are not used in the sequence of the time-sequential color representation in this example structure, but may be used in other time-sequential color representations, must also be defined.

However, for example, when the types of color representations that may be used is 7 colors, or 8 colors including the OFF state, if only 3 colors, or 4 colors including the OFF state, appear in a certain sequence of the time-sequential color representation at all times, with the structure of FIG. 9, the number of types of pallet numbers (PN) 44 may be 4. That is, in correspondence to the time-sequential color representation instruction, 3 colors of the above-described 7 colors may be dynamically assigned to PN001 to PN003. In addition, when the number of types of color representations simultaneously appearing in a sequence of time-sequential color representation is 3 colors, or 4 colors including the OFF state, it is possible to select 3 arbitrary colors from 2⁹ types of colors which is a combination of 9 bits of the pallet data 46, not from the above-described 7 colors.

In other words, PN001 only means the color representation 1, that is, the first color, and the color is not determined in advance. The color is defined in the pallet data table 111 and the number of combinations of the colors is the number of combinations which can be represented by the pallet data 46. Therefore, practically, compared to the case of FIG. 6 where the color of PN001 is fixedly defined as red, the degree of freedom of selection of the color representation differs significantly. Therefore, the structure of FIG. 9 has a possibility of reducing the capacity of the pallet data table 111 more than the structure of FIG. 6, and thus with the same capacity of the pallet data table 111, the structure of FIG. 9 can realize a greater variety of color representations than the structure of FIG. 6.

In addition, when, for example, all of the portions lighted in red are to be changed to green in the structure of FIG. 9, only 1 correction is necessary, that is, (000111000) may be set in PN001 of the pallet data table 111. Such a configuration is possible because the referral of the pallet data table 111 is limited to a one-direction referral of providing the pallet number (PN) 44 to extract the pallet data 46, and thus there is no problem even when both PN001 and PN002 are the same pallet data 46 of (000111000) representing green.

Moreover, when, for example, the brightness of red is to be reduced in the structure of FIG. 9, only 1 change of the pallet data 46 of PN001 of the pallet data table 111 to (110000000) is required. In this manner, the structure is also more flexible with respect to the change of the pallet data table 111.

Alternatively, it is also possible to employ a configuration based on the structure of FIG. 9 and in which the pallet data table 111 is dynamically re-generated in synchronization with the switching of the lighting cycle 48 as described above with reference to FIG. 8. In this case, a combined method may be used such as, for example, when the number of types of color representations appearing from the lighting cycles C₁ to C₃ is 14, and three or more further color representations appear in the lighting cycle C₄, so that the number of types of color representations exceeds 16, the pallet data table 111 is re-assigned from PN001 in the lighting cycle from C₄ to C₅.

For example, when the table generating unit 64 is actually constructed with software executed on a microcomputer external to the IC of the display driving circuit 50, such a configuration may be employed. With this configuration, in the structure of FIG. 9, no limitation would exist on the number of types of color representations that can simultaneously appear so long as the number of types of the pallet numbers (PN) 44 is greater than or equal to the number of types of the channel unit numbers (CN) 21.

As described, by constructing the pallet data table 111 and the time-sequential pallet number table 113 in an explicitly separated manner, it is possible to realize any of the structures of FIGS. 6-9. In addition, with the use of the structure described above with reference to FIG. 9, it is possible to realize a more flexible time-sequential color representation within a limited capacity of the table storage unit 62 and to easily change the time-sequential color representation.

What is claimed is:

1. A display driving circuit connected to a display channel unit which comprises a plurality of display devices which can display in different colors from each other and which enables a plurality of types of color representation by time-sequentially changing each of driving conditions of the display devices, the display driving circuit comprising:
a channel driving unit which can drive the plurality of the display devices of the display channel unit independently from each other; and
a pallet data setting unit which uses a plurality of types of pallet data correlating a channel driving condition, which is a driving condition of each display device of the display channel unit, and each type of color representation, manages a time-sequential color representation instruction, which is instructed in advance in a separated manner, to the pallet data correlated to the color representation, and information representing a movement of the color representation on a time axis, assigns the pallet data corresponding to each color representation along a time sequence according to the time-sequential color representation instruction which is instructed in advance, and sets driving conditions of the plurality of the display devices of the display channel unit.

2. A display driving circuit connected to a display channel unit which comprises a plurality of display devices which can display in different colors from each other and which enables a plurality of types of color representation by time-sequentially changing each of driving conditions of the display devices, the display driving circuit comprising:
a channel driving unit which can drive the plurality of the display devices of the display channel unit independently from each other;
a cycle switching unit which switches, for a plurality of lighting cycles, the lighting cycle sequentially to a next lighting cycle every time a lighting period of the lighting cycle elapses;
a table storage unit which stores a table generated based on a plurality of types of pallet data correlating a channel driving condition, which is a driving condition of each display device of the display channel unit, and each type of color representation and according to a time-sequential color representation instruction which is instructed in advance, the table storage unit storing a pallet data table associating the pallet data correlated with the color representation and a pallet number, and a time-sequential pallet number table associating an order of the lighting cycle and the pallet number; and
a pallet data setting unit which refers to the stored pallet data table and the stored time-sequential pallet number table, obtains pallet data corresponding to each lighting cycle, assigns the obtained pallet data while sequentially switching the pallet data according to switching of the lighting cycle, and sets the driving condition of each display device of the display channel unit.

3. A display driving circuit connected to a plurality of groups of display channel units in which a plurality of display devices which can display in different colors from each other are combined into a group and which enables a plurality of types of color representation by time-sequentially changing each of driving conditions of the display devices for each group distinguished by a channel unit number, the display driving circuit comprising:
a plurality of groups of channel driving units each of which is provided for each display channel unit and each of which can drive the plurality of the display devices of the display channel unit independently from each other;
a cycle switching unit which switches, for a plurality of lighting cycles, the lighting cycle sequentially to a next lighting cycle every time a lighting period of the lighting cycle elapses; and
a pallet data setting unit which uses a plurality of types of pallet data correlating a channel driving condition, which is a driving condition of each display device of the display channel unit, and each type of color representation, manages a time-sequential color representation instruction which is instructed in advance in a separated manner to the pallet data correlated to the color representation and information representing a movement of the color representation on a time axis, obtains pallet data corresponding to each display channel unit for each lighting cycle according to the time-sequential color representation instruction which is instructed in advance, assigns the obtained pallet data while sequentially switching the pallet data according to switching of the lighting cycle, and sets the driving condition of each display device of the display channel unit.

4. A display driving circuit connected to a plurality of groups of display channel units in which a plurality of display devices which can display in different colors from each other are combined into a group and which enables a plurality of types of color representation by time-sequentially changing each of driving conditions of the display devices for each group distinguished by a channel unit number, the display driving circuit comprising:
a plurality of groups of channel driving units each of which is provided for each display channel unit and each of which can drive the plurality of the display devices of the display channel unit independently from each other;
a cycle switching unit which switches, for a plurality of lighting cycles, the lighting cycle sequentially to a next lighting cycle every time a lighting period of the lighting cycle elapses;
a table storage unit which stores a table generated based on a plurality of types of pallet data correlating a channel driving condition, which is a driving condition of each display device of the display channel unit, and each type of color representation and according to a time-sequential color representation instruction which is instructed in advance, the table storage unit storing a pallet data table associating the pallet data correlated to the color representation and a pallet number, and a time-sequential pallet number table associating a channel unit number for each order of the lighting cycle and the pallet number; and
a pallet data setting unit which refers to the stored pallet data table and the stored time-sequential pallet number table, obtains pallet data corresponding to each channel unit number for each lighting cycle, assigns the obtained pallet data while sequentially switching the pallet data according to switching of the lighting cycle, and sets the driving condition of each display device of the display channel unit.

5. The display driving circuit according to claim 4, wherein
the table storage unit stores, as the pallet data table, a pallet data table generated in synchronization with switching timing of the lighting cycle.

6. The display driving circuit according to claim 4, wherein
in the pallet data table, association of a plurality of pallet numbers which differ from each other to pallet data representing the same color representation is permitted.

7. The display driving circuit according to claim 4, wherein
in the time-sequential pallet number table, a common pallet number is assigned to pallet numbers of lighting cycles in which the same color representation is realized.

8. The display driving circuit according to claim 4, wherein
the table storage unit includes, as the pallet data, ON-OFF data and display grayscale data for each display device.

9. A display driving system comprising a control device which provides a time-sequential color representation instruction and a display driving circuit which obtains the time-sequential color representation instruction and drives a plurality of display devices, wherein
the display driving circuit is connected to a plurality of groups of display channel units in which a plurality of display devices which can display in different colors from each other are combined into a group and which enables a plurality of types of color representation by time-sequentially changing each of driving conditions of the display devices for each group distinguished by a channel unit number, and
the display driving circuit comprises:
a plurality of groups of channel driving units each of which is provided for each display channel unit and each of which can drive the plurality of the display devices of the display channel unit independently from each other;
a cycle switching unit which switches, for a plurality of lighting cycles, the lighting cycle sequentially to a next lighting cycle every time a lighting period of the lighting cycle elapses; and
a pallet data setting unit which uses a plurality of types of pallet data correlating a channel driving condition, which is a driving condition of each display device of the display channel unit, and each type of color representation, manages a time-sequential color representation instruction which is instructed in advance in a separated manner to the pallet data correlated to the color representation and information representing a movement of the color representation on a time axis, obtains pallet data corresponding to each display channel unit for each lighting cycle according to the time-sequential color representation instruction which is instructed in advance, assigns the obtained pallet data while sequentially switching the pallet data according to switching of the lighting cycle, and sets the driving condition of each display device of the display channel unit.

10. A display driving system comprising a control device which provides a time-sequential color representation instruction and a display driving circuit which obtains the time-sequential color representation instruction and drives a plurality of display devices, wherein
the display driving circuit is connected to a plurality of groups of display channel units in which a plurality of display devices which can display indifferent colors from each other are combined into a group and which enables a plurality of types of color representation by time-sequentially changing each of driving conditions of the display devices for each group distinguished by a channel unit number, and
the display driving circuit comprises:
a plurality of groups of channel driving units each of which is provided for each display channel unit and each of which can drive the plurality of the display devices of the display channel unit independently from each other;
a cycle switching unit which switches, for a plurality of lighting cycles, the lighting cycle sequentially to a next lighting cycle every time a lighting period of the lighting cycle elapses;
an obtaining unit which obtains the time-sequential color representation instruction;
a table generating unit which generates a table necessary for channel driving based on a plurality of types of pallet data correlating a channel driving condition, which is a driving condition of each display device of the display channel unit, and each type of color representation and according to the obtained time-sequential color representation instruction, the table generating unit generating a pallet data table associating the pallet data correlated to the color representation and a pallet number, and a time-sequential pallet number table associating a channel unit number for each order of the lighting cycle and the pallet number;
a table storage unit which stores the generated table; and
a pallet data setting unit which refers to the stored pallet data table and the stored time-sequential pallet number table, obtains pallet data corresponding to each channel unit number for each lighting cycle, assigns the obtained pallet data while sequentially switching the pallet data according to switching of the lighting cycle, and sets the driving condition of each display device of the display channel unit.

11. The display driving system according to claim 10, wherein
the table storage unit stores, as the pallet data table, a pallet data table generated in synchronization with switching timing of the lighting cycle.

12. The display driving system according to claim 10, wherein
in the pallet data table, association of a plurality of pallet numbers which differ from each other with pallet data representing the same color representation is permitted.

13. The display driving system according to claim 10, wherein
in the time-sequential pallet number table, a common pallet number is assigned to pallet numbers of lighting cycles in which the same color representation is realized.

14. The display driving system according to claim 10, wherein
the table storage unit includes, as the pallet data, ON-OFF data and display grayscale data for each display device.
